(19) United States
(12) Patent Application Publication
(10) Pub. No.: US 2019/0097477 A1
(43) Pub. Date: Mar. 28, 2019

(54) Synchronous Reluctance Motor

(71) Applicant: Siemens Aktiengesellschaft, Muenchen (DE)

(72) Inventors: Sven Ludwig Kellner, Erlangen (DE); Ingo Geier, Cadolzburg (DE)

(73) Assignee: SIEMENS AKTIENGESELLSCHAFT

(21) Appl. No.: 16/143,006

(22) Filed: Sep. 26, 2018

(30) Foreign Application Priority Data
Sep. 27, 2017 (EP) 17193418.5

(51) Int. Cl. H02K 1/24; H02K 15/02

(52) U.S. Cl. CPC H02K 1/246; H02K 15/022

(57) ABSTRACT

A synchronous reluctance motor includes a stator and a rotor, where a laminate section of the rotor has flux barriers, and where the rotor is formed with a high number of poles.

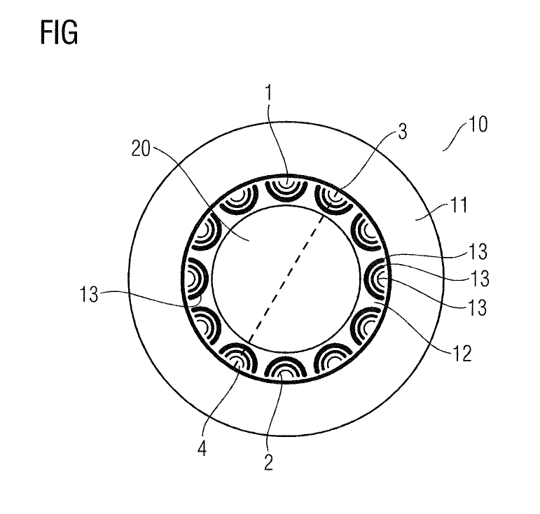

### BACKGROUND OF THE INVENTION

### 1. Field of the Invention

The invention relates to a synchronous reluctance motor having a stator and a rotor, where a laminate section of the rotor has flux barriers.

### 2. Description of the Related Art

For production or processing machines in industrial manufacturing, drive solutions that are based on synchronous technology are often required. Synchronous motors have a high efficiency. Such motors are also used for applications in which a stable rotational speed that is independent of the load is required. In particular, synchronous technology can be used advantageously even in the partial-load range on account of high efficiency requirements.

Permanent-magnet synchronous motors with a high number of poles are known from the prior art. These motors have a very high performance with a very compact design. They are very expensive, in particular on account of the magnets needed. For cost-sensitive markets, which demand motors having a high torque and high performance at the same time as a low price, there are therefore no solutions currently available.

What are known as synchronous reluctance motors, which are cheap and therefore used, for example, in the textile sector, are also known from the prior art. Synchronous reluctance motors of this kind having 2 or 4 poles are known. U.S. Pat. No. 5,818,140 describes a synchronous reluctance motor of this kind in more detail. However, the required high torque values for production machines in the sectors described above, such as the plastics sector or furthermore also the metal/deforming sector, cannot be achieved using known synchronous reluctance motors of this kind.

### SUMMARY OF THE INVENTION

Against this background, it is an object of the present invention to provide an improved synchronous motor for applications having a high required torque and at the same time for cost-sensitive applications.

This and other objects and advantages are achieved in accordance with the invention by a synchronous reluctance motor having a stator and a rotor, where a laminate section of the rotor has flux barriers, and where the rotor is formed with a high number of poles.

In the present application, a synchronous reluctance motor is understood to mean a motor consisting of a rotor and a stator, in which the physical effect of the reluctance is used in a synchronous operation for the rotational movement of the rotor. Instead of the term rotor, the term armature could also be used. No magnets are involved at all in this case. Movement or rotation or influencing of the rotor is also not produced on account of electric currents in the rotor. In contrast, flux barriers are used in the laminate section of the rotor, where the flux barriers have a lower conductivity in comparison to other sections of the laminate section. The difference of the high and low magnetic conductance results in a desired reluctance torque, which causes the rotation of the rotor.

Consequently, no electric currents that cause the drive arise in the rotor and there are neither magnets nor similar field-generating elements located in the armature. In the case of a changing stator magnetic field, which is realized, in particular, through suitable energization of windings or coils in the stator, interfacial forces are produced at the transition from the flux barrier regions to the rest of the regions, where the interfacial forces cause a rotation into the magnetically optimum position. Here, a magnetically optimum position means that the system attempts to move from a state having an increased system energy on account of a high magnetic resistance to a state with a low system energy having a low magnetic resistance.

In accordance with the invention, the rotor is provided with a high number of poles so that a central part of the armature that is not permeated by flux is produced. Until now, rotors having at most four poles have been used in the prior art. This is due to the fact that, when there are four poles, the flux barriers can be arranged so that the effect of the interfacial forces is optimized. In this case, no iron is “lost”, i.e., there are approximately no iron regions on the laminate section that are unused. The flux barriers extend almost up to the center in order to achieve the greatest possible reluctance effect. Until now, there has been no deviation from this optimum state.

In the case of a rotor having a high number of poles, in accordance with the invention, many poles are arranged next to one another. A pole is formed by a flux barrier stack, i.e., from a plurality of regions having a low conductance in the laminate section, which are arranged, for example, symmetrically along a virtual imaginary axis, which lies in the plane of the laminate section or perpendicular on the rotor axis and which extends through the virtual center point of the rotor. The individual flux barrier regions appear arcuate, for example, and are open toward the outside toward the stator.

An armature laminate stack having a high number of poles yields the advantage that a high torque is possible at low rotational speeds. The low rotational speeds are produced directly from the high number of poles of the rotor given an identical network frequency of the motor. This causes higher torques. Usage possibilities of the synchronous reluctance motor having a high number of poles, in which a transmission is omitted, are therefore conceivable. A synchronous reluctance motor having a high number of poles can consequently be configured as a direct drive. This is advantageous depending on the application on account of the affordability or the simplicity or a required design.

The high number of poles can achieve a further advantage, i.e., a hollow shaft can be provided in the central part of the armature. In contrast, conventional synchronous reluctance motors, in particular having four poles, have no possibility for accommodating a hollow shaft. The central part of the rotor, where the central part is extremely small and is not provided with flux barriers, only has space for a solid shaft.

The overall size of the synchronous reluctance motor having a high number of poles will typically be greater than that of a conventional synchronous reluctance motor or that of a permanent-magnet synchronous motor having a comparable torque. However, the less compact design is less relevant for the applications of interest than the saving in price achieved thereby. A diameter of the described synchronous reluctance motor having a high number of poles is typically in the range of over 600 cm, for example 800 cm. In conventional synchronous reluctance motors having an axis height of approximately 160 cm and a rotor diameter of approximately 10 cm, approximately a diameter of 15 mm remained for a shaft. Providing a hollow shaft is therefore impossible on account of the required stability. Owing to the overall larger design and the removal of the previous rotor having four poles, the central part of a laminate section, which was previously considered useless, can intentionally be left empty in order to install the shaft.

Configurations in which a compact design (comparable to that of permanent-magnet synchronous motors or conventional synchronous reluctance motors) is retained and, for example, in which a solid shaft is fitted are likewise conceivable. The more torque that is intended to be generated at the shaft, i.e., the more magnetic flux that has to be placed virtually on the surface of the laminate section to generate the torque, the greater the diameter of the laminate section ultimately has to be, however, in the case of an identical length of the motor. Applications in which a particularly high performance, i.e., particularly high torques, is required will therefore also advantageously have larger designs, depending on requirements with a solid shaft or a hollow shaft.

In accordance with one embodiment, on account of the flux barriers, the laminate section has regions having a high conductance, in particular formed from iron-based material, and regions having a low conductance, in particular air-filled recesses. The interfacial forces consequently act at the iron-air transition. Here, the flux barrier regions are arranged, in particular, in an arcuate manner symmetrically to axes through the center point of the rotor. In particular, a plurality of arcuate flux barrier regions are arranged behind one another symmetrically to an axis through the center point of the rotor, i.e., symmetrically from the inside to the outside along the laminate section. The interspaces between the flux barriers, i.e., in particular the iron remaining through the recesses, are likewise arranged in an arcuate manner. Arcuate means here that the shape is similar to a section of an arc whose imaginary center point is outside of the rotor and indeed is located outside on the side of the pole, such as on the extension of the imaginary axis extending in the plane of the laminate section originating in the imaginary rotor center point along the flux barriers of the pole beyond the stator. The arcs are consequently open toward the outside. In particular, three recesses, which are arranged on top of one another in an arcuate manner, can be provided for each pole. The higher the number of poles that the rotor is formed to have, the more iron would remain virtually lost in the interior of the rotor, because interfaces can no longer be arranged between the recess and the laminate, where these interfaces could contribute to strengthening of the orientation of the rotor into the optimum magnetic position. The provision of a hollow shaft that is precisely so large that regions of the laminate section that are substantially traversed by flux barriers are present is therefore particularly advantageous.

In accordance with one embodiment, the rotor has at least six poles, in particular at least ten poles and in particular at least 20 poles. Even the provision of six poles makes it possible to use a larger hollow shaft than previously. Here, an interface-suitable surface, which can be used for a hollow shaft, inside the rotor is also virtually lost. In the case of ten or more poles and, in particular, in the case of 20 or more poles, the effect is particularly advantageous and great. In the region, in particular, the effect of the low rotational speed and of the correspondingly great torque given the same power is particularly advantageous.

In accordance with another embodiment, the stator has a number of stator windings adapted to the number of rotor poles. In terms of the distributed windings of the stator, the stator is to be adapted to the number of poles of the rotor provided, where the number is stipulated by the embodiment of the armature laminate stack.

In accordance with a further embodiment, a hollow shaft is provided in the rotor. This hollow shaft is advantageous, in particular, for extrusion methods, in which the synchronous reluctance motor having a high number of poles is intended to be used. For example, the provision of a hollow shaft for such applications makes it possible to mount or remove an extruder screw.

In accordance with one embodiment, the diameter of the hollow shaft is approximately three quarters of the rotor diameter. The provision of a sufficient large amount of poles by way of the laminate section having a corresponding large amount of flux barrier stacks arranged along the circumference of the laminate section makes a correspondingly large hollow shaft possible. The hollow shaft advantageously occupies the entire central part of the armature, where the central part is not permeated by flux.

In accordance with another embodiment, the synchronous reluctance motor comprises a direct drive. For this purpose, the required torque is taken into account in the configuration of the flux barriers and the selection of the number of poles in order to be able to achieve a correspondingly matching rotational speed.

In yet a further embodiment, the synchronous reluctance motor has an axis height of more than 300 cm. Axis heights of approximately 400 cm are likewise conceivable. The effect of a sufficiently large torque on account of the low rotational speed is thus increased further by the provision of a correspondingly large diameter of the rotor having a correspondingly large amount of transitions between flux regions and flux barrier regions, where the transitions contribute to the interfacial forces.

It is also an object of the invention further to provide a production machine for performing a plastic-processing method, in particular an extrusion method, having a synchronous reluctance motor in accordance with the above-described embodiments. For example, the use of the described synchronous reluctance motor in plastic-processing machines, such as injection-molding machines, blow-molding machines, extruders or other presses, in which large forces and high performance are required, is advantageous. The application for machine tools, such as in rotary table drives, is also advantageous.

In accordance with an embodiment, the hollow shaft is configured to feed-through an extruder screw.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment with the aid of the FIGURE, in which:

The FIGURE is cross-sectional illustration of the synchronous reluctance motor in accordance with the invention.

### DETAILED DESCRIPTION OF THE EXEMPLARY EMBODIMENTS

The FIGURE shows, schematically, a cross section through a motor having a rotor and a stator, where the cross section extends along a plane, which is perpendicular to the axis of rotation of the armature. A cross section of this kind is also referred to as a laminate section. The motor is a synchronous reluctance motor 10 in accordance with an exemplary embodiment of the invention. Here, the stator 11, as is usual in synchronous motors, is constructed from windings, which are energized individually or in groups or one after another via a converter in order to be able to generate a changing magnetic field. The rotor 12 is located inside the stator 11.

Depicted is a laminate section of the rotor 12 having flux barriers 13, which are typical of a synchronous reluctance motor. The flux barriers 13, or the alternating regions of flux barriers 13 and, for example, regions made of iron, which form the basis of the rotor 12, are responsible for the physical effect of the torque generation on account of the reluctance. A stack of flux barriers appears, for example, in a form such that a plurality of arcuate flux barrier sections are arranged concentrically around an imaginary center point of the rotor. The opening of the arcuate sections points toward the outside, here. The recesses that form the flux barriers accordingly increase in length and width toward the inside.

In the illustrated example, a twelve-pole rotor 12 is illustrated. A first pole 1 has in each case an associated second pole 2, with which the first pole 1 forms what is known as a pole pair. A third pole 3 likewise has an opposite pole 4. In particular, only an even number is possible as the number of poles for a rotor.

The number of poles provided stipulates, at the same time, the dimensions or the extent of a flux barrier stack that forms a pole. The more poles that are provided, the smaller an imaginary diameter of the flux barrier arcs for each pole. Here, an expedient minimum size of a flux barrier stack should be adopted and the size of the design of the motor should be adapted accordingly. At the same time, the region on the laminate section that cannot contribute to the formation of the interfacial forces at the transition between the air and the iron becomes larger accordingly. The region can be disregarded with respect to a reluctance torque that can be generated. At the same time, however, precisely the region, in which a relatively large hollow shaft is provided in the armature, can be used advantageously used.

A synchronous reluctance motor having a high number of poles entails the advantages, as illustrated above, that high torques can be generated at low rotational speeds and consequently an embodiment as a direct drive is possible. It is consequently possible to omit a transmission. A hollow shaft can be provided inside the armature and can be used advantageously for applications in which large forces are required and at the same time cost-effective motors are intended to be used. The low costs are produced, in particular, through the omission of magnets and, instead of this, the use of synchronous reluctance technology. On account of the embodiment with a high number of poles, it is nevertheless possible to generate high torques. At the same time, a high degree of energy efficiency in the entire operating range is ensured, i.e., during partial load and full load.

Although the invention has been described and illustrated in detail by way of the exemplary embodiment, the invention is not restricted by the disclosed examples and other variations can be derived herefrom by a person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A synchronous reluctance motor comprising:
a stator; and
a rotor having a laminate section which includes flux barriers;
wherein the rotor is formed with a high number of poles.

2. The synchronous reluctance motor as claimed in claim 1, wherein, on account of the flux barriers, the laminate section has regions having a high conductance formed from iron-based material, and air-filled recesses forming regions having a low conductance.

3. The synchronous reluctance motor as claimed in claim 1, wherein the rotor has at least 6 poles.

4. The synchronous reluctance motor as claimed in claim 3, wherein the rotor has at least 10 poles.

5. The synchronous reluctance motor as claimed in claim 4, wherein the rotor has at least 20 poles.

6. The synchronous reluctance motor as claimed in claim 2, wherein the rotor has at least 6 poles.

7. The synchronous reluctance motor as claimed in claim 6, wherein the rotor has at least 10 poles.

8. The synchronous reluctance motor as claimed in claim 7, wherein the rotor has at least 20 poles.

9. The synchronous reluctance motor as claimed in claim 1, wherein the stator has a number of stator windings adapted to the number of rotor poles.

10. The synchronous reluctance motor as claimed in claim 1, wherein the rotor includes a hollow shaft.

11. The synchronous reluctance motor as claimed in claim 10, wherein a diameter of the hollow shaft is approximately ¾ of the rotor diameter.

12. The synchronous reluctance motor as claimed in claim 1, wherein the synchronous reluctance motor comprises a direct drive.

13. The synchronous reluctance motor as claimed in claim 1, wherein the synchronous reluctance motor has an axis height of more than 300 cm.

14. A production machine for performing a plastic-processing method, the production machine including the synchronous reluctance motor as claimed in claim 1.

15. The production machine as claimed in claim 14, wherein the hollow shaft is configured to feed-through an extruder screw.

16. The production machine as claimed in claim 14, wherein the plastic-processing method comprises an extrusion method.
